(19) United States
(12) Patent Application Publication
(10) Pub. No.: US 2015/0327352 A1
(43) Pub. Date: Nov. 12, 2015

(54) POWER-OPERATED WORK APPARATUS

(71) Applicant: MAKITA CORPORATION, Aichi (JP)

(72) Inventors: Yoshinari KIKUCHI, Aichi (JP); Tomoyuki KUTSUNA, Aichi (JP); Hiroki SUGIYAMA, Aichi (JP)

(73) Assignee: MAKITA CORPORATION, Aichi (JP)

(21) Appl. No.: 14/706,189

(22) Filed: May 7, 2015

(30) Foreign Application Priority Data
May 8, 2014 (JP) 2014-097155

(51) Int. Cl. H05F 3/04; F04B 17/05; A47L 5/36; F04D 15/00

(52) U.S. Cl. CPC H05F 3/04; F04D 15/0066; F04B 17/05; A47L 5/36

(57) ABSTRACT

A power-operated work apparatus has a machine body which includes an electrostatic charge inducing member that may induce electrostatic charges thereon, and is adapted to be used with the machine body maintained electrically ungrounded. The work apparatus includes: a grip which is adapted to be grasped and held by a user and has an outer surface to be touched by the user and an inner surface forming an inner space; an electroconductive body member which forms an electroconductive body exposed on at least a part of the outer surface of the grip; and an electroconductive line member which is configured to be charged with the electrostatic charges induced on the electrostatic charge inducing member and has a part disposed inside the grip neighboring to and without electrically touching the electroconductive body forming member. The electrostatic charges are to spark from the electroconductive line member to the electroconductive body member.

### TECHNICAL FIELD

The present invention relates to a portable power-operated work apparatus such as a backpack blower apparatus having a machine body which includes an electrostatic charge inducing member that may induce electrostatic charges thereon, and adapted to be used with the machine body maintained electrically ungrounded. More particularly, the present invention relates to a power-operated work apparatus so contrived that electrostatic charges induced on the machine body during the operation of the work apparatus would be discharged without directly attacking the user's body. The invention is particularly useful for an air blowing work apparatus comprising an air blowing fan which includes a volute casing and rotating blades both made of resin and is likely to induce electrostatic charges thereon.

### BACKGROUND INFORMATION

Blower apparatuses and suction apparatuses have been conventionally known and used in the art as a kind of work apparatuses used for blowing off or sucking in fallen leaves on the ground or the like. A backpack blower apparatus or a backpack suction apparatus comprises a power-operated blower unit including a rotary fan driven by a drive motor (an internal combustion engine or an electric motor) to suck in and blow out air. The blower unit is mounted on a back carrier frame which is piggybacked by an operator, whereby the apparatus is used by the operator with the machine body maintained electrically ungrounded above the ground or the floor. According to the operation of the blower unit, electrostatic charges carried on particulates or dust included in the running air or electrostatic charges generated due to the friction between the particulates and the structural members of the blower unit are likely to be accumulated (built up) on the machine body. This happens more often with the air blowing apparatus including a volute casing and rotating blades of an air blowing fan both made of resin. As electrostatic charges are accumulated on the machine body to reach a certain high (positive or negative) voltage with respect to the ground voltage, the charges will discharge toward the ground. If such a discharge phenomenon occurs, sparking to the operator's body, the operator will experience an uncomfortable sharp electric attack. The sparking discharge is likely to occur particularly toward the hand holding the apparatus from the machine parts near the hand.

Such problems with electrostatic charges have been conventionally recognized in connection with the blower apparatuses and the suction apparatuses, and various configurations have been proposed and used to prevent an unwanted attack of an electrostatic discharge. An example of a suction/blower apparatus with an arrangement for preventing an electrostatic discharge attack is disclosed in U.S. Pat. No. 6,552,891 B1. The arrangement comprises a grounding element provided in the surface of the handle of electrically insulating material, which grounding element is electroconductively connected to the electrical ground of the motor. This configuration is to electroconductively connect the hand of the operator to the electrical ground of the drive motor so that the electrostatic charges on the hand will be conducted away to minimize the voltage difference between the operator and the drive motor which difference would cause a spark discharge.

Another example of a power-operated blower apparatus with an arrangement for preventing electrostatic discharge attack is disclosed in JPP No. 4,305,731 B. The arrangement comprises a handle and a throttle cable extended from the engine into the handle, wherein the handle is electrically connected to the throttle cable so that the electrostatic charges which may be generated on the handle will be conducted away to the throttle cable which serves as the electrical ground of the apparatus.

### SUMMARY OF THE INVENTION

In view of the foregoing circumstances, therefore, it is a primary object of the present invention to provide a power-operated work apparatus such as a backpack blower apparatus having a machine body which includes an electrostatic charge inducing member that may induce electrostatic charges thereon, and adapted to be used with the machine body maintained electrically ungrounded, in which the electrostatic charges that may accumulate on the machine body will be prevented from discharging directly to the operator's body so that the operator would not be attacked by an uncomfortable electrostatic discharge spark from the grip which the user grasps and holds when in use.

According to the present invention, the object is accomplished by providing a power-operated work apparatus having a machine body which includes an electrostatic charge inducing member that may induce electrostatic charges thereon, and adapted to be used with the machine body maintained electrically ungrounded, the apparatus comprising: a grip adapted to be grasped and held by a user, the grip having an outer surface to be touched by the user and an inner surface forming an inner space; an electroconductive body member for forming an electroconductive body exposed on at least part of the outer surface of the grip; and an electroconductive line member configured to be charged with the electrostatic charges induced on the electrostatic charge inducing member and having a part disposed inside the grip neighboring to and without electrically touching the electroconductive body member.

With the power-operated work apparatus configured as above in which a part of the electroconductive line member is disposed inside the grip neighboring to and without electrically touching the electroconductive body member, an electrostatic discharge spark, if any, would occur between the electroconductive line member and the electroconductive body member within the grip thereby preventing a direct discharge spark against the operator's body, which will keep the operator from unexpected uncomfortable attacks.

In the work apparatus configured as above, at least part of the electroconductive body member may be exposed in the inner space of the grip preferably at a plurality of positions confronting the electroconductive line member, so that discharge sparking positions may be different from time to time to avoid a possible carbonization of a particular concentrated point, which in turn avoid deterioration of a particular part and lengthen the service life of the work apparatus.

The present invention is particularly useful in the case where the power-operated work apparatus is a power-operated blower apparatus comprising an air blowing fan including a volute casing and rotating blades both made of resin, which is more likely to induce electrostatic charges during the operation.

Further, in the work apparatus configured as above, the work apparatus can be of a type which is operated by an internal combustion engine and the throttle wire extending from the carburetor to the grip for controlling an output power of the internal combustion engine can be utilized as the electroconductive line member, so that the work apparatus can dispense with an additional member for conducting electrostatic charges.

Further, in the work apparatus configured as above, the grip may preferably include a hip-position throttle lever for controlling the apparatus.

The present invention is useful in that it provides a power-operated work apparatus having a machine body which includes an electrostatic charge inducing member and adapted to be used with the machine body maintained electrically ungrounded, wherein chances of electrostatic charges at high-voltage directly sparking to the user will be minimized, so that the user can comfortably use the work apparatus at ease.

### BRIEF DESCRIPTION OF THE DRAWINGS

For a better understanding of the present invention, and to show how the same may be practiced and will work, reference will now be made, by way of example, to the accompanying drawings, in which:

FIG. 1 is a perspective view, as seen from the rear right side, of a backpack blower apparatus as an embodiment of the power-operated work apparatus according to the present invention;

FIG. 2 is a left side view of a grip of the backpack blower apparatus according to an embodiment of the present invention, which grip is molded in two right-and-left pieces and is viewed with the left side piece taken away;

FIG. 3 is a vertical sectional view of the grip taken along the arrowed line of FIG. 2, in which the right and left pieces are assembled together;

FIG. 4 is an enlarged view of the part encircled in FIG. 3;

FIG. 5 is another enlarged view of the part shown in FIG. 4, but with a modified configuration;

FIG. 6 is still another enlarged view of the part shown in FIG. 4, but with a further modified configuration; and

FIG. 7 is a left side view of a grip of the backpack blower apparatus according to an embodiment of the present invention, which grip is of a modified configuration from that shown in FIG. 2.

### DETAILED DESCRIPTION OF EMBODIMENTS OF THE INVENTION

The invention and its embodiments can now be better understood by turning to the following detailed description of the preferred embodiments with reference to the accompanying drawings. The invention will hereunder be described about a backpack blower apparatus as an embodiment of the power-operated work apparatuses hereunder. It should, however, be understood that the invention is applicable not only to a blower apparatus, but also to a suction apparatus and a blower/suction apparatus. Further, the present invention is applicable not only to a backpack blower apparatus, but also to a hand-held blower apparatus. Still further, the present invention is useful for other kinds of work apparatuses which may possibly generate electrostatic charges. Still further, the invention is applicable not only to an apparatus with an internal combustion engine, but also an apparatus with an electric motor.

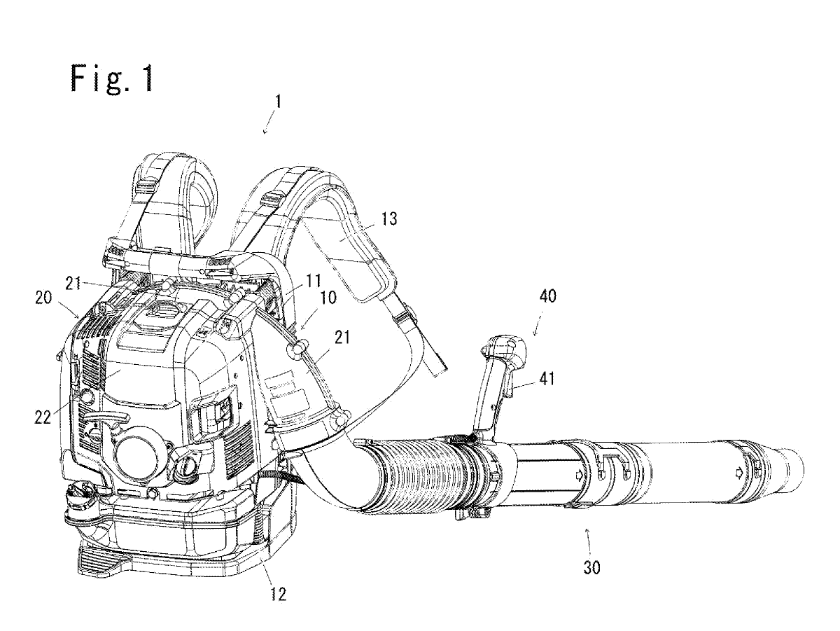

FIG. 1 shows an overall view of a backpack blower apparatus 1 according to an embodiment of the present invention, as viewed from the right rear side. The backpack blower apparatus 1 comprises a back carrier frame 10, a blower unit 20 mounted on the back carrier frame 10, and a blow-off tube (airflow tube) 30 connected to a blow-out duct (airflow duct) 21 of the blower unit 20, wherein the blower unit 20 sucks in air from the ambiance and blows out air from the blow-out duct 21, which air is strongly blown out ahead from the distal end of the blow-off tube 30. The back carrier frame 10 serves for the operator to piggyback the blower unit 20, and includes a back contacting member 11 to be disposed vertically along the back of the operator and a base member 12 extending horizontally rearward from the lower edge of the back contacting member 11, exhibiting an L-shaped side view. To the back contacting member 11 are fixed a right-and-left pair of shoulder straps 13 so that the operator can piggyback the back carrier frame 10.

The blower unit 20 includes an air blowing fan driven by an internal combustion engine 22 to suck in air from the ambiance and blow out air from the blow-out duct 21. In the illustrated embodiment, the air blowing fan is so configured that air blowing blades made of resin rotate within a volute casing made of resin, and according to the operation of the blower unit, electrostatic charges carried on particulates or dust included in the running air or electrostatic charges generated due to the friction between the particulates and the structural members of the blower unit are likely to be induced and accumulated on the machine body of the air blowing fan. The backpack blower apparatus 1 thus has a machine body which includes an electrostatic charge inducing member that may induce electrostatic charges thereon. As the metallic parts of the machine body such as the engine and the carburetor are charged with the generated electrostatic charges, other metallic parts connected to such metallic parts are also charged to the same electrostatic potential. The blow-off tube 30 coupled to the blow-out duct 21 is provided with a grip 40 for the operator to hold and manipulate the blow-off tube 30 while operating the blower apparatus 1.

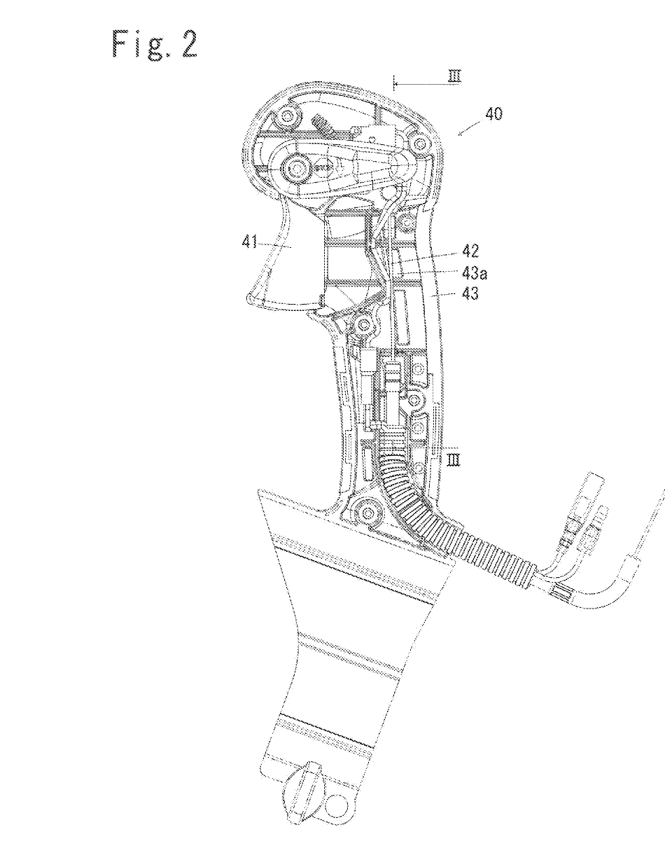

FIG. 2 shows the inside structure of the grip 40. The grip 40 is provided with a throttle lever 41 for controlling the output power of the engine 22. The throttle lever 41 is connected to a throttle wire 42 extending from the carburetor of the engine 22 to the inside of the grip 40 so as to regulate the opening degree of the throttle valve of the engine 22, so that the output power of the engine 22 is controlled according to the pulling amount of the throttle lever 41. The throttle wire 42 is a wire made of stainless steel, and is an electroconductive line member which is electrically connected to the machine body of the engine 22, and therefore is charged with the electrostatic charges generated by the air blowing fan together with the machine body. Although not shown in the drawings, the throttle wire is connected to the carburetor (not shown) in this embodiment, where the engine 22 together with the carburetor constitutes the machine body of the blower apparatus. In the case where the throttle wire is arranged to pass near the volute casing, the throttle wire may additionally charged with electrostatic induction from the volute casing, and maybe further from the nozzle near the grip 40.

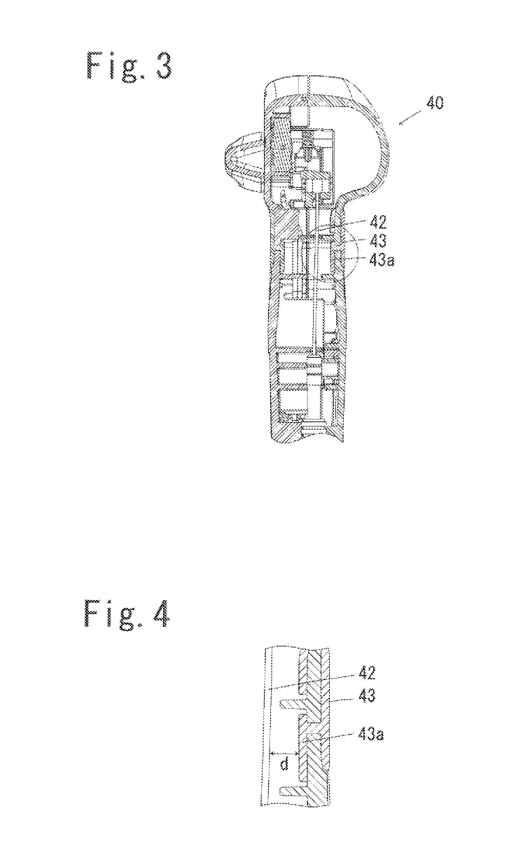

As shown also in FIG. 3, the grip 40 is provided with an electroconductive body member 43 made of electroconductive elastomer which forms an electroconductive area exposed on and covering at least part of the outer surface of the grip 40. With this configuration, the hand of the operator grasping the grip 40 touches the electroconductive elastomer area member 43 exposed on the outer surface of the grip 40, whereby the electroconductive elastomer area member 43 is electrostatically at the ground potential together with the operator. Under this condition, as electrostatic charges accumulate on the machine body of the engine 22 and raise the electrostatic potential of the throttle wire 42, i.e. the electroconductive line member, up to a dischargeable potential, the discharge of the accumulated electrostatic charge from the throttle wire 42 to the ground potential occurs toward the electroconductive elastomer area member 43 which is nearer to the throttle wire 42 than the hand of the operator is. Thus, the hand of the operator will not receive a direct discharge attack from the throttle wire 42, which relieves the operator from feeling uncomfortable. On the other hand, if the electroconductive elastomer area member 43 were not provided, the discharge from the throttle wire 42 would occur toward the hand of the operator penetrating through the insulating resin material of the body of the grip 40, thereby attacking the operator's hand directly to give an uncomfortable feeling to the operator.

The electroconductive elastomer area member 43 is so configured that at least integral part 43a thereof is exposed in the inner space of the grip 40, the part 43a confronting the throttle wire 42 without electrically touching the throttle wire 42. In this case, the distance d between the throttle wire 42 and the inner exposed part 43a of the electroconductive elastomer area member 43 is the shorter the better in view of the breakdown voltage of the air, and may preferably be less than 10 mm, and more preferably be between 0.5 mm and 10 mm, and most preferably be between 1 mm and 5 mm. In the illustrated embodiment, this distance is set to be approximately 1 mm. Further, the electroconductive elastomer area member 43a is exposed in the inner space of the grip 40 preferably at a plurality of positions, so that the sparking positions may be different from time to time, which will decrease the possibility of carbonization of the electroconductive elastomer area member 43a at a particular point due to repetitive sparking at the particular position. Thus, the durability of the blower apparatus will be increased.

As the electroconductive elastomer area member 43 is not in direct touch with the throttle wire 42, and thus the operator's body is not forcibly made equipotential, there will be no fear that the operator's body would be floating above the ground and be charged with electrostatic charges, which might possibly cause uncomfortable discharges from the operator's body toward the ground or environmental matters.

According to the above described configuration, a condition will be rightly established between the throttle wire 42 and the electroconductive elastomer area member 43 in which discharging will easily occur before the voltage of the accumulated electrostatic charges may rise to a great extent. Thus, the possibility of direct discharge attacks on the operator's hand will be greatly decreased. The electroconductive elastomer area member 43 may not necessarily be a discrete member made of electroconductive elastomer covering the outer surface of the grip 40 as illustrated in the drawings, but may be an integral same member with the grip 40 itself entirely made of electroconductive elastomer. Or alternatively, the electroconductive elastomer area member 43 may alternatively be made of metal which is electroconductive material.

From the viewpoint that the electrostatic charges on the throttle wire 42 shall easily discharge toward the electroconductive elastomer area member 43, the distance d is the shorter the better, as long as the two do not touch each other. And if the distance is longer than 10 mm, the sparking potential (firing potential) will accordingly increase and the discharge current will be accordingly strong, and the operator may feel uncomfortable when the current from the electroconductive elastomer area member 43 flows through the body of the operator to the ground, even though a sparking attack on a skin point is avoided. In this connection, the distance d is preferably less than 10 mm.

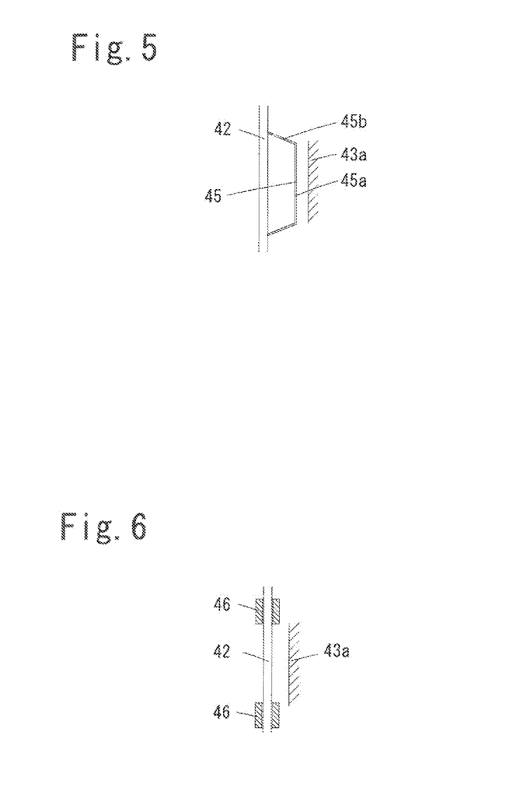

FIG. 4 is an enlarged view of the part encircled in FIG. 3, showing the structural relation among the throttle wire 42, the electroconductive elastomer area member 43 and its inner exposed part 43a. In order to stably keep the electrical distance between the throttle wire 42 and the inner exposed part 43a of the electroconductive elastomer area member 43, the configuration of the encircled part may be modified, for example, as shown in FIG. 5 or FIG. 6. FIG. 5 shows a configuration in which a metal piece 45 is provided at a fixed distance from the inner exposed part 43a by means of some supporting member (not shown) with a part 45a serving as a discharge electrode confronting the inner exposed part 43a at a fixed distance and with a bent spring part 45b serving as a slidable spring contact against the throttle wire 42. This configuration is advantageous in that the positional unstableness (swaying) of the throttle wire 42 will not influence the electrostatic discharge voltage. FIG. 6 shows another configuration in which guide sleeves 46, 46 are provided at fixed positions from the inner exposed part 43a by means of some supporting member (not shown) to guide and maintain the throttle wire 42 therethrough at a fixed distance from the inner exposed part 43a. This configuration is advantageous in that the fluctuation of the throttle wire in distance from the inner exposed part 43a is effectively prevented.

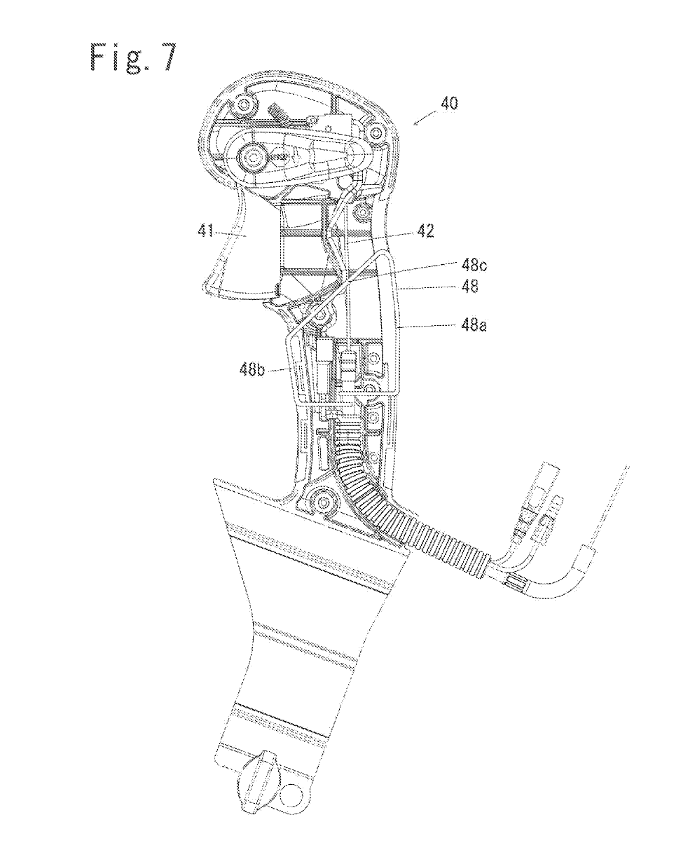

A further modification of the discharge mechanism is shown in FIG. 7, in which a bent metallic rod 48 is provided as the electroconductive body member in place of the electroconductive elastomer area member 43 in FIG. 3. The bent metallic rod 48 has two outer parts 48a and 48b located on the outer surface of the grip 40 and an inner part 48c located in the inner space of the grip 40. The inner part 48c traverses the inner space of the grip 40 crossing over the throttle wire 42 without touching the throttle wire 42. With this configuration, the outer parts 48a and 48b are touched by the hand of the operator grasping the grip 40, while the inner part 48c confronts the throttle wire 42. Thus, when the electrostatic potential of the throttle wire 42 is raised with the accumulated electrostatic charges, the discharge sparking will occur between the throttle wire 42 and the metallic member 48, without directly attacking a skin point of the hand of the operator.

The electroconductive members used in this invention can be of any material that permits the discharge pass of static electricity, and generally of a material whose resistivity is in the order of 10**5 (the fifth power of 10) ohm-meters or less.

Further, the electroconductive material provided within the grip may not necessarily be in the shape or form illustrated above, but may also be in a brushlike shape or form having bristles inducing easy discharge of static electricity.

While the invention has been described about a backpack blower apparatus in which the grip is provided on the blow-off tube that is located on the right side of the blower apparatus and the grip is provided with the electrostatic attack avoiding configuration, the invention can be embodied in a backpack blower apparatus of a type that has a hip-position grip including a hip-position throttle lever, i.e. a throttle lever for controlling the engine power output positioned on the left side of the apparatus near the waist of the operator, independent of the blow-off tube.

According to the present invention, as described above, the possibility of electrostatic charges at a high voltage directly attacking the operator's body is avoided in a power-operated work apparatus which is used with the machine body maintained electrically ungrounded floating above the ground. Thus, the operator can comfortably use the apparatus without fearing unexpected electrostatic discharge attacks.

While the invention has been described about a backpack blower apparatus as an embodiment of the power-operated work apparatus, the present invention is not necessarily limited to a blower apparatus, but may be practiced in an air blowing work apparatus such as a suction apparatus or a blower/suction apparatus. Further, the invention is applicable not only to a backpack type work apparatus, but also to a handheld type work apparatus. Still further, the spirit of the invention can be advantageously employed in other kinds of work apparatus which might cause an electrostatic discharge problem. The invention is also useful with a work apparatus driven by an electric motor, in addition to a work apparatus driven by an internal combustion engine.

1. A power-operated work apparatus having a machine body which includes an electrostatic charge inducing member that may induce electrostatic charges thereon, and adapted to be used with the machine body maintained electrically ungrounded, the apparatus comprising:
a grip adapted to be grasped and held by a user, the grip having an outer surface to be touched by the user and an inner surface forming an inner space;
an electroconductive body member for forming an electroconductive body exposed on at least part of the outer surface of the grip; and
an electroconductive line member configured to be charged with the electrostatic charges induced on the electrostatic charge inducing member and having a part disposed inside the grip neighboring to and without electrically touching the electroconductive body member.

2. A power-operated work apparatus as claimed in claim 1, wherein the electroconductive body member is made of electroconductive elastomer.

3. A power-operated work apparatus as claimed in claim 2, wherein at least part of the electroconductive body member is exposed in the inner space of the grip at a plurality of positions confronting the electroconductive line member.

4. A power-operated work apparatus as claimed in claim 1, wherein the electroconductive body member is made of an electroconductive rod having at least a part located on the outer surface of the grip and an inner part located in the inner space of the grip confronting the electroconductive line member.

5. A power-operated work apparatus as claimed in claim 1, wherein the power-operated work apparatus is a power-operated blower apparatus, wherein the electrostatic charge inducing member is an air blowing fan including a volute casing and rotating blades both made of resin.

6. A power-operated work apparatus as claimed in claim 1, wherein the work apparatus is operated by an internal combustion engine included in the machine body, the machine body further including a carburetor coupled to the internal combustion engine, wherein the electroconductive line member is constituted by a throttle wire extending from the carburetor to the grip for controlling an output power of the internal combustion engine.

7. A power-operated work apparatus as claimed in claim 5, wherein the work apparatus is operated by an internal combustion engine included in the machine body, the machine body further including a carburetor coupled to the internal combustion engine, wherein the electroconductive line member is constituted by a throttle wire extending from the carburetor to the grip for controlling an output power of the internal combustion engine.

8. A power-operated work apparatus as claimed in claim 6, wherein the grip is a hip-position grip and includes a hip-position throttle lever.

9. A power-operated work apparatus as claimed in claim 7, wherein the grip is a hip-position grip and includes a hip-position throttle lever.
